(19) United States
(12) Patent Application Publication
(10) Pub. No.: US 2014/0004401 A1
(43) Pub. Date: Jan. 2, 2014

(54) LEAD ACID BATTERY PLATE

(71) Applicant: WIRTZ MANUFACTURING COMPANY, INC., Port Huron, MI (US)

(72) Inventor: John O. Wirtz, Fort Gratiot, MI (US)

(73) Assignee: WIRTZ MANUFACTURING COMPANY, INC., Port Huron, MI (US)

(21) Appl. No.: 14/013,783

(22) Filed: Aug. 29, 2013

Related U.S. Application Data
(63) Continuation of application No. 10/626,961, filed on Jul. 25, 2003, now abandoned.

(51) Int. Cl. H01M 4/14

(52) U.S. Cl. CPC H01M 4/14
USPC 429/99; 429/234; 429/96; 156/60

(57) ABSTRACT

A battery plate for a lead acid battery includes a grid having a plurality of interconnected wires, an electro-chemically active material paste applied to the grid, at least one reinforcing member disposed in the paste, and the paste is cured. Preferably the reinforcing member is embedded in the active material, provides structural support for the active material and reduces the likelihood that in use the active material paste will shed from the grid.

### REFERENCE TO RELATED APPLICATION

This application is a continuing application of copending application, Ser. No. 10/626,961, filed on Jul. 25, 2003, the benefit of which is claimed under 35 U.S.C. 120 and the disclosure of which is incorporated herein by reference in its entirety.

### FIELD OF INVENTION

This invention relates generally to lead acid batteries, and more particularly to plates for these batteries.

### BACKGROUND OF THE INVENTION

Lead acid batteries include battery plates composed of a grid and active material applied to the grid. Typical lead acid battery grids are formed by casting, stamping or punching and have a reticulated framework including a plurality of spaced apart longitudinally extending wires that are interconnected by a plurality of wires extending transversely thereto. The wires define a grid having open spaces between adjacent portions of the wires. The grid is usually “over pasted” so that the wires are completely embedded in and surrounded by the paste, and the paste fills the open spaces between the wires.

Common failure modes of lead acid batteries include corrosion of the positive grid, shedding of the paste from the surface of the positive plate, and shrinkage of the paste from the negative grid wires. One form of paste shedding from the positive plate is the paste shedding off the surface of the positive plate during cycling of the battery. While both the paste and the grid may still be useable after such shedding, during cycling when the positive grid grows or expands, the paste may shed off the surface of the plate and this causes a reduction in performance of the battery which will in time cause the battery to fail to meet performance ratings in laboratory tests, and will also cause early failure in service. One form of paste shrinkage in the negative plate is the paste shrinking away from the negative grid wires which causes the paste to lose contact with the negative wires, and the battery will fail to make performance ratings and can also cause early failure in service.

### SUMMARY OF THE INVENTION

A battery plate for a lead acid battery includes a grid having a plurality of interconnected wires, an electro-chemically active material paste applied to the grid, and at least one reinforcing member disposed in the paste. In the presently preferred embodiment, the reinforcing member is embedded in the paste, provides structural support for the paste and reduces the likelihood that paste will shed or shrink from the grid.

In one form, the reinforcing member is a thin sheet of material that includes glass fibers. This sheet of material can be incorporated into the battery plate before or after the paste has been applied to the grid. If the sheet of material is applied to the plate after the paste has been applied to the grid, rollers may be used to press the sheet of material into the paste. Preferably, the sheet of material is fully embedded in the paste, and is permeable so that the paste may flow through the sheet of material.

Some of the objects, features and advantages of the invention include providing a battery plate for a lead acid battery that reduces shedding and shrinkage of paste from battery grids, improves the performance of battery grids, improves the durability, reliability and average useful life of batteries incorporating the plates, can be manufactured with limited additional cost compared to conventional batteries, can be manufactured with existing tooling and machinery, and is of relatively simple design and economical manufacture and assembly. Of course, battery plates embodying the present invention may achieve some, all, different or none of these advantages.

### BRIEF DESCRIPTION OF THE DRAWINGS

These and other objects, features and advantages of the present invention will be apparent from the following detailed description of the preferred embodiments, appended claims and accompanying drawings in which:

FIG. 1 is a perspective view partially in section of a lead acid battery;

FIG. 2 is a plan view of a grid for a battery plate of the lead acid battery;

FIG. 3 is a fragmentary cross-sectional view of the battery grid of FIG. 2 including a reinforcing member disposed adjacent to one face of the battery grid and paste covering the grid and reinforcing member;

FIG. 4 is a fragmentary cross-sectional view like FIG. 3 which also includes an additional reinforcing member disposed adjacent to the other face of the battery grid;

FIG. 5 is a fragmentary cross-sectional view like FIG. 4 illustrating the battery grids and reinforcing members being passed through compression rollers; and

FIG. 6 is a fragmentary cross-sectional view illustrating a battery plate formed according to one presently preferred embodiment of the invention.

### DETAILED DESCRIPTION OF THE PREFERRED EMBODIMENTS

Referring in more detail to the drawings, FIG. 1 illustrates a lead acid battery 10 with a housing 12 having a case 14 and a top cover 16 both constructed from a plastic material such as polypropylene. The case 14 has a plurality of integrally molded battery cell dividers 18 providing a plurality of battery cell wells 20 within the housing 12. A battery cell 22 is disposed within each of the wells 20 between the dividers 18 and has a set or book of interleaved positive plates 24 and negative plates 26, and a separator 28 disposed between each plate of different polarity to prevent them from touching and producing a short circuit within the cell 22. A positive plate strap 30 and a negative plate strap 32 electrically connect together the associated positive and negative plates 24, 26 of each cell 22 across the top of plates. To connect the individual cells 22 together in series, an intercell connector 34 made of lead is disposed between and welded to the positive plate strap 30 and adjoining negative plate strap 32 of adjoining cells 22 in series. A positive terminal post 36 is connected to the positive plate strap 30 of the first cell and a negative terminal post 38 of lead is connected to the negative plate strap 32 of the last cell. Each post 36, 38 projects through the cover 16 and is sealed to the cover and welded to its associated strap 30, 32 of the same polarity. In use, dilute sulfuric acid solution fills the majority of the remaining space within each well 20 and is the electrolyte necessary to produce the chemical reactions which take place within each battery cell 22. As will be apparent to skilled persons, other materials may be used for the housing, the battery plates, and the electrolyte, as desired.

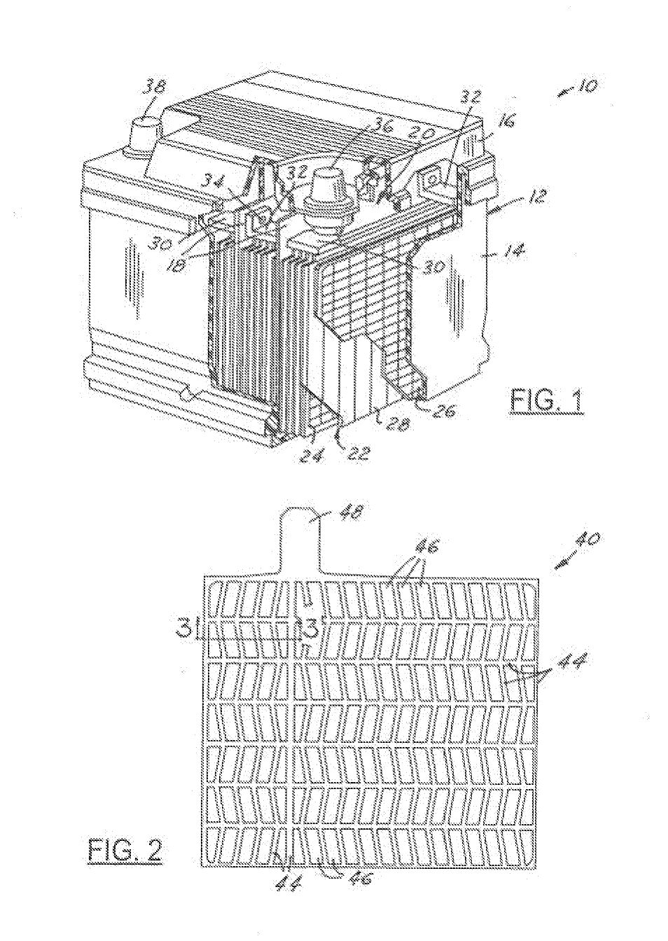

As noted above, each book of battery plates preferably includes a plurality of positive plates 24 and a plurality of negative plates 26. Each of the positive and negative plates 24, 26 includes a battery grid 40 covered and preferably embedded in an active material that is usually applied to the grid in the form of a paste 42 and cured. As shown in FIG. 2, each grid 40 includes a reticulated framework of wires 44 with at least some of the wires 44 intersecting each other and defining open spaces 46 between adjacent wires 44. Each grid preferably also has a tab 48 extending from some of the wires. To facilitate connecting together plates of the same polarity, the tab 48 on each positive plate grid is offset from the location of the tab 48 on each negative plate grid so the positive plate strap 30 engages only positive plates 24 and the negative plate strap 32 engages only negative plates 26.

As shown in FIG. 3, a reinforcing member 50 may be disposed adjacent to one face 52 of the grid 40 and some electrochemically active paste 42 may be disposed onto the grid 40 and down onto and into the reinforcing member 50. The reinforcing member 50 may be a generally flat sheet of material that may include glass fibers, other reinforcing fibers, or other reinforcement. The fibers may be elongated and overlapped in any desired manner. The reinforcing member 50 is preferably permeable to the paste and permits the paste 42 to saturate and, more preferably, flow through it so that the reinforcing member 50 becomes embedded in the paste 42 during manufacture of the battery plate 24 or 26. The reinforcing member 50 may be porous, have openings formed therein or may be formed of a material otherwise permeable to the paste without significant openings. This reinforcing member is not like conventional cellulose pasting paper or glass microfiber pasting paper used to support wet battery paste when applying it to a grid and to prevent stacked wet pasted battery grids from sticking to each other or to processing equipment during manufacture of lead acid battery plates. The wet battery paste cannot permeate or flow through conventional cellulose pasting paper and/or glass microfiber pasting paper.

A suitable reinforcing member of a fiberglass sheet may have an air permeability or air flow rate at 100 Pa of at least 4,000 liters per square meter per second (L/m²s), desirably in the range of about 4,000 to 8,000 L/m²s, and preferably in the range of about 5,000 to 6,000 L/m²s. This fiberglass sheet may have a thickness of at least about 0.12 millimeters (mm), desirably in the range of about 0.14 to 0.30 mm, and preferably in the range of about 0.14 to 0.20 mm; a weight of at least 18 grams per square meter of area (g/m²), desirably about 20 to 40 g/m² and preferably about 22 to 28 g/m²; a longitudinal tensile strength of at least about 45 Newtons per 50 millimeters (N/50 mm), desirably in the range of about 50 to 90 N/50 mm, and preferably about 60 to 80 N/50 mm; and a transverse tensile strength of at least 25 N/50 mm, desirably in the range of about 30 to 50 N/50 mm and preferably in the range of about 35 to 45 N/50 mm. A suitable glass fiber reinforcing member is commercially available from Owen Corning, P. O. Box 30, Liversedge, West Yorkshire, England WF15 88A as glass fiber vail product BL25A.

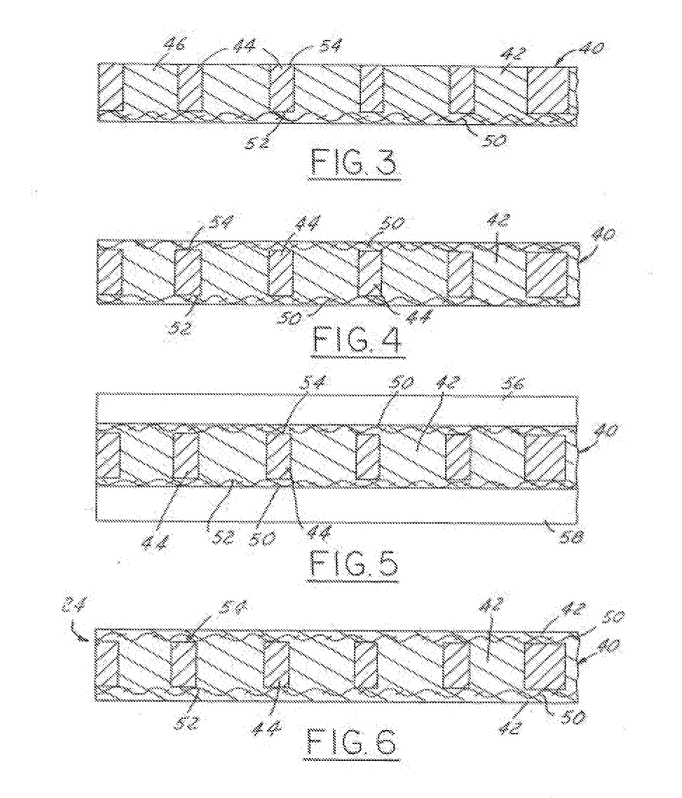

In the presently preferred embodiment, as shown in FIG. 4, after paste 42 is applied to the grid 40 and to the reinforcing member 50 on one face 52 of the grid 40, a second reinforcing member 50 is disposed on the opposite face 54 of the grid 40. The reinforcing member 50 on the opposite face 54 is preferably pressed into the paste 42 and presently is made of same material as or a similar material to the first reinforcing member 50 so that it is permeable to the paste 42 and preferably becomes embedded in the paste 42.

As shown in FIG. 5, after the reinforcing members 50 and paste 42 have been applied to the grid 40, the entire unit may be passed between a pair of rollers 56, 58 to compress the reinforcing members 50, grid 40 and paste 42 together. Preferably, the reinforcing members 50 are firmly embedded in the paste 42 and become part of the paste layer and provide structural integrity to the paste 42 when cured and increase resistance to bending of the entire plate or assembly. Preferably, as shown in FIG. 6, the reinforcing members 50 are embedded in and “over pasted” so that a layer of paste 42 overlies the reinforcing members 50 with the grid 40 disposed between the reinforcing members 50.

The reinforcing members 50 may have a thickness that is the same as, greater than or less than the thickness of the grid 40. Reinforcing members 50 may be generally planar and lie generally parallel to the plane of the grid 40. The reinforcing members 50 may overlie a portion of or the entire grid 40. The reinforcing members 50 may extend at least partially between the faces 52, 54 of the grid 40, within the open spaces 46 defined between adjacent wires 44 of the grid 40. While the presently preferred embodiment has been disclosed as having a pair of reinforcing members 50, one on each of the opposed faces 52, 54 of the grid 40, only one reinforcing member 50 may be used, and it may overlie part or all of one face or both faces 52, 54 of the grid 40.

While not wishing to be held to any particular theory, it is currently believed and theorized that the reinforcing members 50 disposed in the paste 42 provide structural rigidity to the paste 42 when cured and in use reduce shedding and shrinkage of the cured paste 42 from the grid 40, thereby increasing the durability, reliability and effective useful life of the battery plate 24, 26. Further, by reducing shedding and shrinkage of the active material, the performance of the plate 24, 26 is improved during its effective useful life.

Those skilled in the art will recognize that the description of the presently preferred embodiments has been provided in terms of description and not limitation. Various modifications and amendments to the lead acid batteries and battery plates can be made without departing from the spirit and scope of the invention as defined by the appended claims. For example, while the reinforcing member has been disclosed as comprising a sheet or mat of material, the reinforcing member could comprise a plurality of individual members, or even individual fibers or groups of fibers or smaller pieces of material disposed in the paste and on the grid. Further, while certain objects, features and advantages have been set forth with respect to the presently preferred embodiments of the invention, a battery plate and/or lead acid battery falling within the spirit and scope of the appended claims may perform all, some or none of the listed advantages, or achieve objects and advantages different from those set forth herein.

1. A battery plate for a lead acid battery, comprising:
a grid including a plurality of interconnected wires, and a plurality of open spaces defined between at least some of the wires;
an electro-chemically active cured paste carried by the grid in at least some of the open spaces, covering at least some of the wires and having outer faces; and
at least one separate reinforcing member of a separate thin sheet of reinforcing material including reinforcing glass fibers which separate sheet is permeable to uncured paste, separate from the uncured paste prior to the uncured paste being applied to the sheet of material and grid, when applied the uncured paste flows into the sheet of material and open spaces of the grid and in the cured paste the separate sheet of reinforcing material is firmly and permanently embedded in and fixed in one of the outer faces of the cured paste generally parallel to the outer face and the separate sheet structurally supports the cured paste and reinforces the cured paste and the grid and is a separate sheet embedded and fixed in the outer face of the cured paste when the battery plate is in a lead acid battery.

2. The battery plate of claim 1 wherein the reinforcing member is substantially completely embedded in the cured paste.

3. The battery plate of claim 1 wherein the reinforcing member is completely covered by the cured paste.

4. The battery plate of claim 1 wherein the sheet of a material is porous to and permeated by the uncured paste.

5. The battery plate of claim 1 wherein the reinforcing member overlies a majority of at least one face of the grid.

6. The battery plate of claim 1 wherein the grid is generally planar and has two opposed sides, and a separate reinforcing member of a thin sheet of reinforcing material including overlapped reinforcing glass fibers is disposed at least in part on each opposed side of the grid.

7. The battery plate of claim 6 wherein the reinforcing members overlie at least a majority of the area of each side of the grid.

8. The battery plate of claim 6 wherein the reinforcing member disposed on each side of the grid includes in the sheet of material elongated reinforcing fibers.

9. The battery plate of claim 1 wherein the sheet of material is porous to and permits the uncured paste to flow through and cover the sheet of material.

10. The battery plate of claim 1 wherein the plate is one of a positive battery plate and a negative battery plate.

11. A lead acid battery, comprising:
a housing;
at least one battery cell carried by the housing and having at least one positive plate and at least one negative plate, at least one plate including a grid having a plurality of interconnected wires and a plurality of open spaces defined between at least some of the wires,
an electro-chemically active cured paste carried by the grid in at least some of the open spaces and covering at least some of the wires, and
a separate reinforcing member of a thin sheet of reinforcing material having reinforcing fibers and the sheet of material is porous and permeable to uncured paste, separate from the uncured paste prior to the uncured paste being applied to the sheet of reinforcing material and the grid, and when applied the uncured paste flows into the separate sheet of reinforcing material and open spaces of the grid and in the cured paste the sheet of material is firmly embedded in and permanently fixed in the cured paste and extends generally parallel to the grid and in the battery remains a separate sheet of reinforcing material embedded and fixed in the outer face of the cured paste and reinforces the cured paste and the grid and retains the cured paste on the plate.

12. The battery of claim 11 wherein said at least one plate is a positive plate.

13. The battery of claim 11 wherein said at least one battery cell includes a plurality of positive plates and a plurality of negative plates.

14. The battery of claim 11 wherein each positive plate and each negative plate includes a grid having a plurality of interconnected wires and a plurality of open spaces defined between at least some of the wires, an electro-chemically active paste in at least some of the open spaces between the wires, carried by the grid and covering at least some of the wires, and the at least one reinforcing member is firmly embedded and permanently fixed in the cured paste of each grid.

15. The battery of claim 11 wherein a plurality of battery cells are disposed in the housing.

16. The battery of claim 11 wherein the overlapped fibers include glass fibers.

17. A battery plate for a lead acid battery, comprising:
a grid including a plurality of interconnected wires, and a plurality of open spaces defined between at least some of the wires;
an electro-chemically active cured paste carried by the grid in at least some of the open spaces, covering at least some of the wires and having outer faces; and
at least one separate reinforcing member of a separate thin sheet of reinforcing material including overlapped reinforcing glass fibers which separate thin sheet is permeable by uncured paste, separate from the uncured paste prior to the uncured paste being applied to the sheet of material and grid, when applied the uncured paste flows into the sheet of material and open spaces of the grid and in the cured paste the separate sheet of reinforcing material is firmly and permanently embedded in and fixed in one of the outer faces of the cured paste generally parallel to the outer face and the separate sheet structurally supports the cured paste and reinforces the cured paste and the grid and remains as a separate sheet embedded and fixed in the outer face of the cured paste when the battery plate is in use in a lead acid battery.

18. A method of making a battery plate for a lead acid battery, comprising the steps of:
providing a battery grid having a plurality of interconnected wires, and a plurality of open spaces defined between at least some of the wires;
applying an electro-chemically active uncured paste to the grid in at least some of the open spaces covering at least a portion of the grid wires with the uncured paste;
disposing a separate reinforcing member with glass fibers and permeable by uncured paste in the uncured paste generally parallel and adjacent to an outer face of the plate; and
curing the uncured paste to fix the reinforcing member in the cured paste.

19. The method of making a battery plate set forth in claim 18 wherein the step of disposing a reinforcing member in the uncured paste is accomplished by placing the reinforcing member on the grid, and applying the uncured paste on the reinforcing member and the grid.

20. The method of making a battery plate set forth in claim 19 wherein after the uncured paste is applied to the reinforcing member and the grid, the battery plate is compressed to force uncured paste through the reinforcing member and onto the battery grid.

21. The method of making a battery plate set forth in claim 18 wherein the step of disposing a reinforcing member in the uncured paste is accomplished by applying uncured paste on the grid, placing the reinforcing member on the uncured paste, and pressing the grid, uncured paste and reinforcing member together to force the reinforcing member into the uncured paste.

22. The method of making a battery plate set forth in claim 18 wherein the step of disposing a reinforcing member in the uncured paste is accomplished by disposing a pair of reinforcing members in uncured paste adjacent to the outer faces of the uncured paste, with one reinforcing member provided on each of a pair of opposed sides of the grid.

23. The method of making a battery plate set forth in claim 22 wherein the step of disposing a reinforcing member in the uncured paste is accomplished by disposing a first reinforcing member adjacent to one side of the grid, applying uncured paste to the grid and onto the first reinforcing member, disposing a second reinforcing member onto the uncured paste, and then pressing at least said second reinforcing member into the uncured paste and adjacent to the outer face of the uncured paste.

24. The method of making a battery plate set forth in claim 18 wherein the grid has a pair of opposed faces, and a first reinforcing member is disposed beneath one face of the grid before the uncured paste is applied to the grid, and the uncured paste is applied onto the other face of the grid so that the paste passes through the open spaces in the grid and into the first reinforcing member, and the second reinforcing member is disposed on the uncured paste generally adjacent to said other face of the grid and the uncured paste permeates the second reinforcing member when the second reinforcing member is pressed into the uncured paste so that the second reinforcing member is substantially covered in uncured paste.

25. The method of making a battery plate set forth in claim 18 which also comprises forming the plate as a positive battery plate.
